(19) United States
(12) Patent Application Publication
(10) Pub. No.: US 2015/0174493 A1
(43) Pub. Date: Jun. 25, 2015

(54) AUTOMATED CONTENT CURATION AND GENERATION OF ONLINE GAMES

(71) Applicant: Onor, Inc., Palo Alto, CA (US)

(72) Inventors: Philipp Michael STAUFFER, Palo Alto, CA (US); Piyush Bansidhar SHAH, Los Gatos, CA (US)

(73) Assignee: ONOR, INC., Palo Alto, CA (US)

(21) Appl. No.: 14/136,366

(22) Filed: Dec. 20, 2013

(51) Int. Cl. A63F 13/63

(52) U.S. Cl. CPC A63F 13/63

(57) ABSTRACT

A computerized method for automated generation of an online game includes automatically selecting an image from a plurality of images based on metadata associated with the selected image and automatically applying a template to the selected image in order to generate a game level including the selected image. New images and associated metadata are uploaded to an image repository. Image metadata may be modified based on user behavior associated with generated online games.

### FIELD OF THE INVENTION

This invention relates generally to the field of online content curation and gaming.

### BACKGROUND

There are a variety of types of online games available today. Users are becoming accustomed to gaming online, but users typically become bored with playing the same games relatively quickly. Users have also become accustomed to various forms of online shopping and e-commerce.

Marketers of goods and products seek to drive brand awareness and sales through various platforms, including online advertising. Traditional online advertising has benefits and limits. In connection with online gaming, one traditional way for a marketer to advertise is to use custom-built promotions and/or applications. Such promotions can be expensive in both development and marketing/operations and can have limited effectiveness with prospects and consumers.

A need, therefore, exists for automatically-generated games that are of interest to users and that benefit marketers and developers of games. A need also exists for methods and systems for automatically generating games.

### SUMMARY OF INVENTION

According to one embodiment, the invention is a computerized method that includes selecting an image based on the image's metadata. A template is applied to the image in order to generate a game level. In this embodiment, the invention can relate to a method of content curation that involves storing images in a repository, each with associated metadata. New images are uploaded to the repository and associated with metadata. Metadata associated with existing images is modified based on a user response to games with those images.

It will be understood that the term “image” as used herein is data representing one or more visual elements. Both “photo” and “video” type data, that is both “still images” and “moving images,” are explicitly contemplated within the scope of the term “image.” Further, a file that includes one or more visual elements but also other elements, such as a file that includes sound elements, text, hyperlinks, or other data, may also be understood to be an “image,” as explained herein.

It will be understood that terms referring to a “game” or “game level” are generally interchangeable, referring to a user interface where a player makes choices or preforms actions to complete one or more objectives. While some of the description found herein refers to a “game” having multiple “game levels” in sequence, descriptions of elements with respect to a “game level” may be equally applied to a “game” and vice versa according to the needs of one of ordinary skill in the art. According to some embodiments, “game levels” may be interposed with other content that may or may not be considered part of a “game.”

It will be understood that the term “metadata” as used with respect to images includes any representation or mechanism that defines the content of the images, whether or not such information is stored as part of file metadata. Information regarding the content of an image may be stored and/or manipulated in many forms, and image “metadata” includes any such information in any form.

The method and system described above can be used by marketers of goods or services and/or their agents (e.g. their retailers) to market such products. It can also be used by causes and charitable organizations or any entity that wants to sell or donate a product and/or raise funds. For example, a marketer can sponsor one or more prizes to allow users to play a game at no expense to the user. The marketer can build goodwill and product recognition through the system by, in part, providing prizes that are awarded to at least one participant in a game.

Another embodiment of the invention is a system that includes an image repository storing a plurality of images, each image including metadata, a template repository, a processor operable to perform actions to generate a game level, and a game repository to store a plurality of generated game levels. In this embodiment, the template repository stores a plurality of game templates, each game template including instructions for automatically generating game levels using one or more images and the metadata of the one or more images. The processor is operable to select at least one image from the image repository based on the metadata included with each image, and automatically apply a template from the template repository to the selected at least one image in order to generate a game level, the game level including the selected at least one image.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a block diagram of a system in which the invention can be practiced;

FIG. 2 is a flow diagram of a method that can be used according to an embodiment of the disclosed subject matter;

FIG. 3A is a layout diagram representing a game template according to an embodiment of the disclosed subject matter;

FIG. 3B is a layout diagram representing a game template according to another embodiment of the disclosed subject matter;

FIG. 3C is a layout diagram representing a game template according to a further embodiment of the disclosed subject matter;

FIG. 3D is a layout diagram representing a game template according to yet another embodiment of the disclosed subject matter;

FIG. 4 is a flow diagram of a method that can be used according to an embodiment of the disclosed subject matter; and

FIG. 5 is a block diagram of another system in which the invention can be practiced.

### DETAILED DESCRIPTION

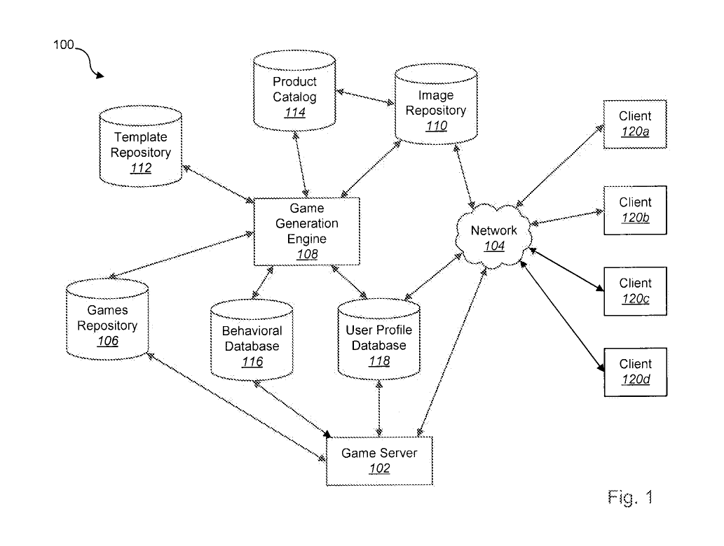

To address the needs set forth above, according to one aspect, the invention relates to a user interaction system and method. FIG. 1 shows one embodiment of a system 100 in which the invention can be practiced. The system 100 includes a game server 102 that is in communication with a network 104 such as the Internet. The game server 102 serves content to users in the form of online games.

As shown in FIG. 1, the game server 102 may draw games from a games repository 106, which may store a plurality of constructed games. Games may be added to the games repository by a game generation engine 108, which may generate games and game levels in accordance with aspects of the present invention.

The game generation engine 108 may create games by drawing from an image repository 110 and a template repository 112. As further described below, the game generation engine 108 may generate a game level by applying a template from the template repository 112 to one or more images from the image repository 110. The image repository 110 may include metadata for each of the images stored therein. The selection of a particular template, the selection of particular images for that template, and the content that is included in the game level may be determined at least in part by the metadata associated with the selected images in the image repository 110, as further described below. The game generation engine 108 may also use data from a variety of other sources, such as a product catalog 114, a behavioral database 116, and a user profile database 118. Each of these sources of data is further described below.

The game server 102 communicates with devices 120a-d through use of the network 104. The client devices 120a-d can each be a personal computer or a wireless mobile device, such as a smart phone or tablet. A personal computer can be any type of computer used by consumers, such as a desktop or a laptop computer. A smart phone can be any type of smart phone known in the art, including, for example, an iPhone or an Android smart phone. A tablet can be any type of tablet known in the art, including, for example, an iPad or an Android tablet. In short, any type of device that allows interaction with the network 104 can be used for the computing devices 120a-d.

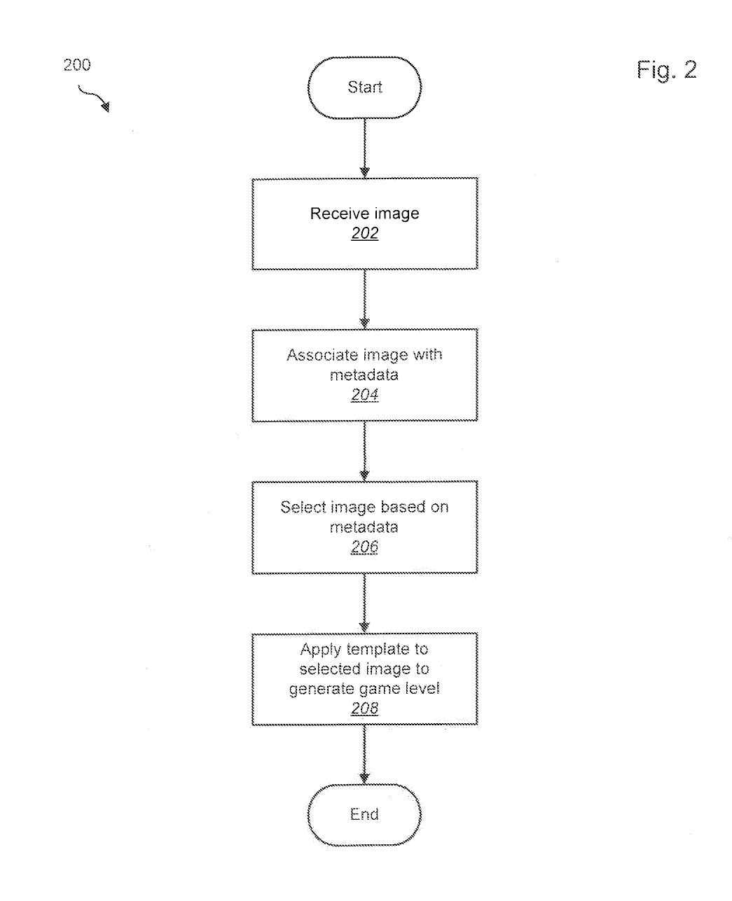

FIG. 2 is a flowchart of a method 200 for content curation and the automated generation of an online game level.

The system receives an image (step 202), which as previously discussed could be any sort of moving or still image with or without additional accompanying data. Images may come from a variety of contexts. In some implementations, the image may be user-generated and/or user-submitted. In some implementations, images may be associated with a product catalog.

User submissions may occur through a variety of mechanisms. As one example, a website may allow users to upload images associated with a particular theme, possibly as part of a form that would allow the user to provide additional information that can be used in associating metadata with the image. As another example, users may be invited to share images relevant over a social network, possibly with a hashtag or other identifier relevant to a particular product or specific to a campaign. In some implementations, users may be able to share images through an application on a mobile device.

Product images may also be generated by a variety of mechanisms. In some implementations, a system may draw images and data from a product catalog, such as the product catalog 114 shown in FIG. 1. A product catalog may associate each product with one or more images of the product as well as data regarding the product and sales of the product. New images may be received by the system each time that the product catalog is updated.

Once the system receives an image, it associates the image with metadata (step 204). The nature of the metadata may depend on the source of the image.

For example, user-submitted images may include metadata provided by the user. The metadata may include any text description that accompanied an uploaded or shared image, and may also include data about the user, such as demographic information. For example, a user-submitted picture of a dog may include a dog breed, color, and name, as well as the age and gender of the owner. User-submitted images may further include metadata from the user's device used to submit the image, such as location information, time and date information, temperature, and other information.

A product image may include metadata associated with the product. For example, a product name, color, style, category, and price may all be included as metadata for a product image. Further metadata relative to specific promotions or features, such as a limited-time discount on the product, may also be included in product metadata. Product metadata may also include links or pointers to resources such as a website where more information regarding a product can be found or where a product is available for purchase.

In some implementations, the image and metadata may be stored in an image repository such as the image repository 110 described above with respect to FIG. 1. Metadata may be further updated by various factors as further discussed below.

Referring again to FIG. 2, the system later selects the image based at least in part on its metadata (206). If the image is stored in an image repository 110, then selecting the image may involve referencing the repository 110 and identifying one or more images with metadata fitting established criteria.

In some implementations, the criteria for selection of images may depend on parameters established by a game generation engine, which may in turn depend on a theme or purpose for a particular game. For example, a game theme may involve dog breeds, and so the system may select an image from the repository that has metadata both identifying it as a dog and identifying a particular breed of dog. Another game may involve yoga poses, and so an image may be selected based on metadata identifying it as a specific pose. In some implementations, these criteria may be from a set list, or may be modified based on user response to previous games as further described below. A game on a particular theme may include multiple levels, each with a selected image, and the system may include various techniques to assure variety in the selected images and differences between levels in a particular game.

Once the system has selected appropriate images, it applies a game template to the image in order to generate a game level (step 208). In some implementations, a game template may be selected from a game template repository 112 as described with respect to FIG. 1. Applying the game template to the image results in a game that displays the image in some way (although it may be in some way occluded or distorted according to the nature of the game). The format of the image may also undergo further processing as part of the game generation process. In addition, some of the metadata associated with the image may be used in generating the game.

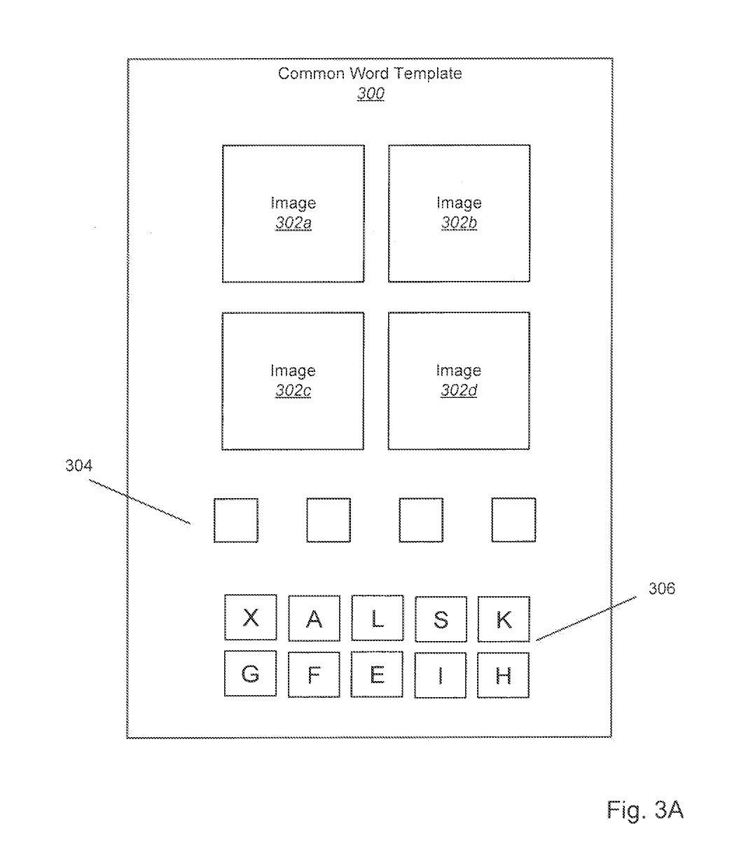

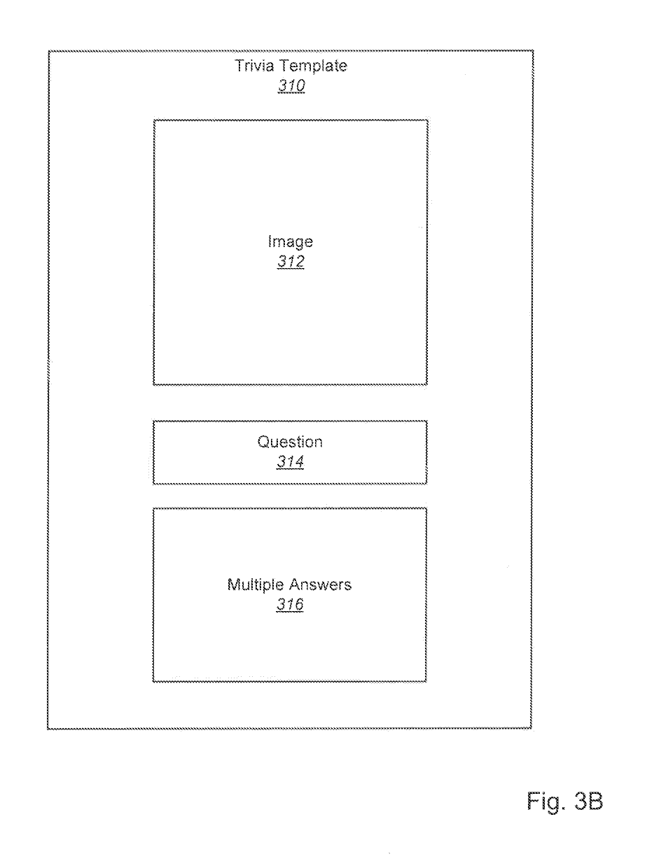

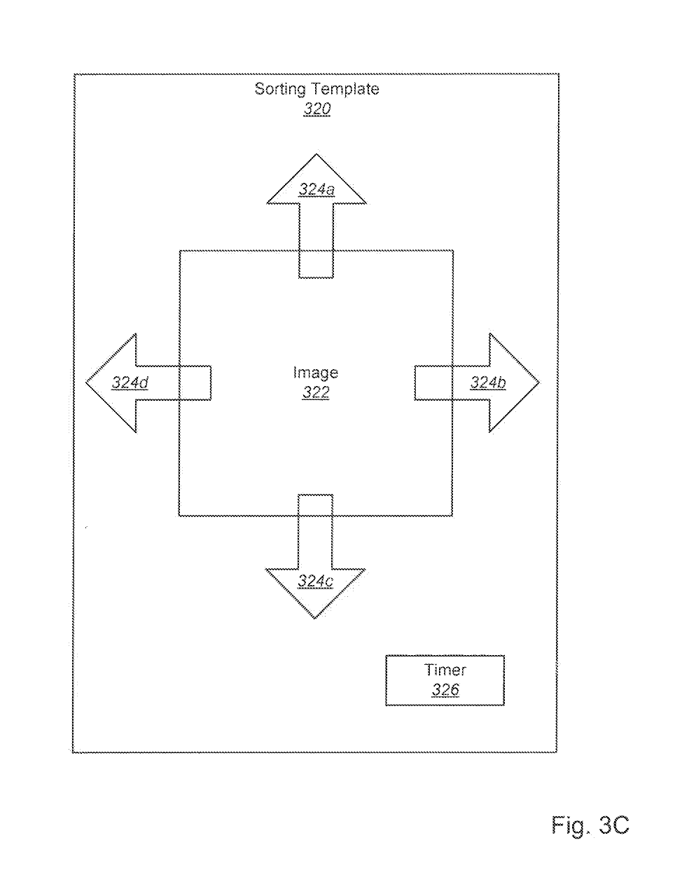

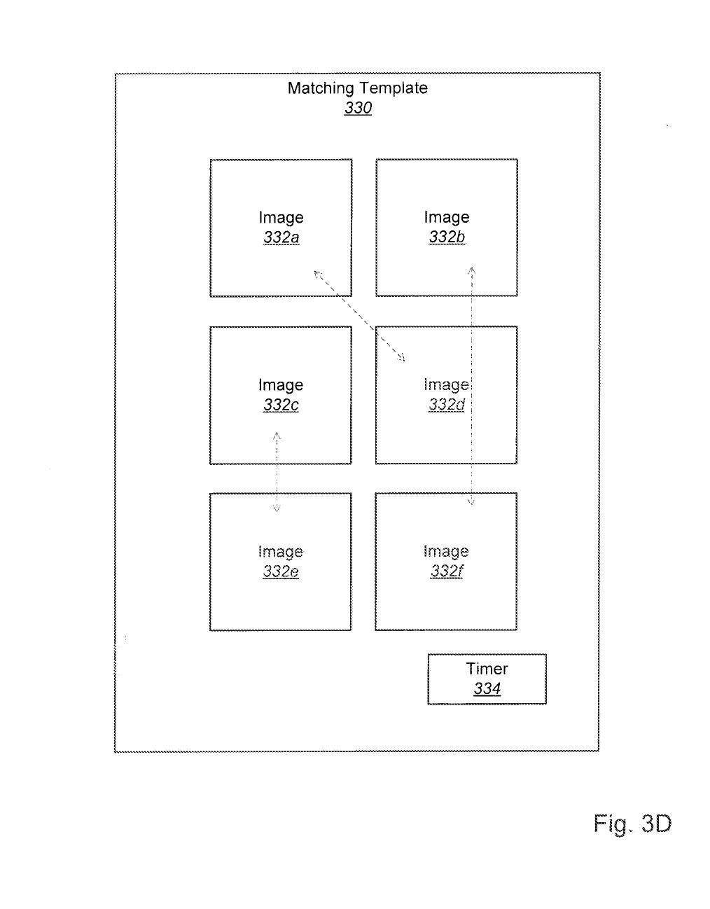

FIGS. 3A-3D show four examples of game templates 300, 310, 320, 330 that may be applied to images within the scope of the invention. In this case, the figures will be understood to illustrate the appearance and layout of a game level generated by using one of the templates.

FIG. 3A shows an example of a game template 300 in which four images, 302a-d, are provided to a user along with a set of blanks 304 and an available field of letters 306. The four images 302a-d are selected as described in this disclosure based on having a common word or phrase in the metadata associated with each of the four images 302a-d. The blanks 304 represent the common word, and the available field of letters 306 include each of the letters within the common word. A user completes the game level by successfully selecting the correct letters from the field of letters 306 to spell the common word. In some implementations, a loss or lower score may be accrued when the user selects wrong letters from the field of letters 306.

FIG. 3B shows an example of a game template 310 in which an image 312 is shown. A question 314 pertaining to the image 312 is also provided along with multiple answers 316, one of which is the correct answer. The correct answer is generated from the metadata associated with the image 312. In some implementations, the incorrect answers supplied for the multiple answers 316 may be metadata associated with other images in an image repository. A user completes the game level by selecting the correct answer. In some implementations, a loss or lower score may be accrued when the user selects wrong answers from the multiple answers 316.

FIG. 3C shows an example of a game template 320 in which an image 322 is shown. A user may slide the picture in any one of four directions 324a-d, each of which assigns the image to a different category. The image 322 is selected for having metadata associated with one of the four categories. In some embodiments, the game created by applying the game template 320 may be timed; the remaining time may be shown on a countdown timer 326. The user may be presented with another image in one of the four categories each time the user makes a category selection for the current image 322. The objective for the user may be to correctly sort as many images as possible in a set period of time. In some implementations, a loss or lower score may be accrued by failing to sort an image in a given amount of time or sorting too many images incorrectly.

FIG. 3D shows an example of a game template 330 in which six images 332a-f are shown. The pictures 332a-f are selected as three pairs based on common metadata between the two pictures comprising the pair. As an example (shown by the dotted lines in FIG. 3D), the pairs may be image 332a with 332d, image 332b with 332f, and image 332c with 332e. The user wins the game level by selecting an image followed by its match, and may lose the game or receive a lower score by selecting two images as a match that are not a matched pair. In some embodiments, the game created by applying the game template 330 may be timed; the remaining time may be shown on a countdown timer 334. Where the game generated by the game template 330 includes multiple levels of image matching, the countdown timer 334 may reset or increase each time a game level is successfully completed by matching all of the pairs. In some implementations, more than three pairs may be selected for a single game level.

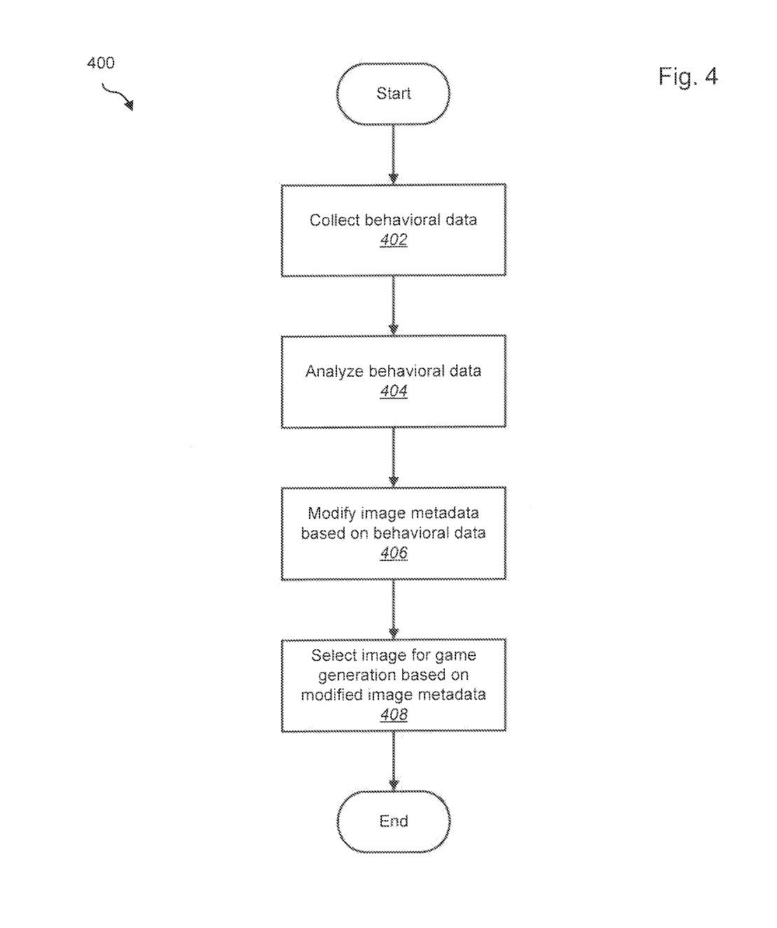

FIG. 4 is a flowchart illustrating one embodiment of a method 400 for using behavioral analytics to modify metadata. Although the method 400 is described with respect to individual images 400, it will be understood that generated games as well as game templates may also include modifiable metadata and may be selected and presented on the basis of behavior analytics.

As part of presenting games to users, the system may collect behavioral data associated with users (step 402). Returning to FIG. 1, the game server 102 that presents games to users may also capture and store user behavior related to the presented games for use by a behavior database 116. The behavior could include user performance on each game, such as how well users perform on particular game levels and relative to particular images.

In some implementations, user behavior other than game performance may also be noted and recorded in the behavior database 116. For example, data regarding user purchasing habits may also be included. In some implementations, user purchasing habits may be associated with games presented to or played by users in order to determine whether particular game levels or images represent effective marketing. Where product images are selected, user buying habits with respect to the displayed product or related products may be included.

The collected behavioral data is then analyzed (step 404). Various metrics for analyzing behavioral data are known in the art of marketing and can be leveraged to determine user response and effectiveness of presented games. In addition, user performance of games can be analyzed to determine whether particular games or game levels are particularly easy or difficult. To the extent that games involve user recognition of images, behavioral data may be used to determine whether certain metadata associated with a particular image is easy or difficult for users to recognize. In some implementations, user response may be used to determine that one or more pieces of metadata associated with an image are erroneous and should be removed or changed.

User behavior that is associated with a particular image may then be used to modify metadata associated with that image (step 406). Modifying metadata may include supplying additional metadata including the results of behavioral analysis for particular images. Images which are shown to be effective for marketing or particularly distinctive for recognition may be so identified by metrics included in their metadata. Metadata identifying the image may be accordingly modified based on user response.

Once the system has modified the metadata, the modified metadata is again used to select images for use in game levels (step 408). Where the metadata is associated with the image in an image repository 110 as in FIG. 1, it is the modified metadata that may then be used in further generation of games. Behavioral analytics therefore allows the system to select more appropriate and effective images over time as modified metadata reflects user behavior and in turn is used in the automated game generation process.

The system may use other methods to analyze images and modify metadata. In some implementations, automated image recognition may be used to add metadata to one or more images in the image repository. For example, an image may be compared to reference images in order to identify objects depicted in the image. Shape, color, and other quantifiable parameters may be identified and added as metadata. Further capabilities for automated image analysis and machine learning known in the art may be used in processing and analyzing stored images.

In some implementations, behavioral analytics may also be used to understand the preference of individual users. FIG. 1 shows a user profile database 118 that may communicate with the behavioral database 116, the game generation engine 108, and the game server 102 in some embodiments of the invention. The user profile database 118 may allow the system to use a number of different metrics and tailoring content to consumers. A user profile within the user profile database 118 may include demographic and other information about a user as well as the user's device. User data may also include data about the channel by which the user came to engage with the system—what website or service the user was engaged with prior to interfacing with the system in order to interact with an online game. Information may be acquired by various means known in the art, including referring servers, URLs submitted by user devices, and browser cookies.

As an example, where a user plays games in which images of clothing in different styles is presented, the system may be able to determine style preferences for the user from the user's interaction with these games. The user's style preferences may be stored in the user profile database for further use in marketing and customized shopping.

As another example, the games a user selects and chooses to play can be associated with the user's profile to determine which further games to generate and present to the user. Additionally, where a user's profile provides information about a user's demographics and interests, the system may be able to tailor content based on the preferences of other users who have profiles similar to the particular user. Metadata on objects such as images, users, user behavior, game templates and such can be used to drive collaborative filtering and therefore more relevant presentation of experiences.

In some implementations, an outcome of a game may depend on the behavior of past players. For example, players may be asked to rank a set of images according to personal preference, and assigned points based on how close the user's ranking matches the previous rankings of other users. As another example, users may be shown a set of images and told to identify the one that is most popular, based on data from other users. In some implementations, the behavior of previous users may affect which images are selected for inclusion in subsequent generation of game levels.

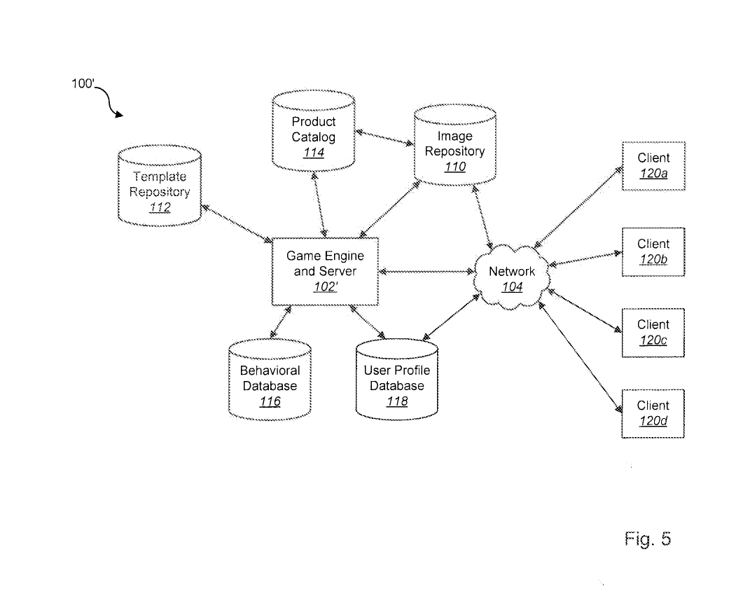

Another embodiment of the present disclosure is illustrated by system 100′ shown in FIG. 5. The components in FIG. 5 are generally analogous to those in FIG. 1 and so are generally given the same numbers. However, rather than a game depository 106 storing games generated by the game generation engine 108 and then later accessed by a game server 102, the system 100′ includes a game engine and server 102′ that dynamically generates and serves games in response to requests from client systems 120a-d. In some implementations, each time a game is needed, the game engine and server 102′ selects one or more images from the image repository 110, applies a selected template from the template repository 112, and serves the resulting game. User response may be analyzed and metadata updated just as discussed above with respect to FIGS. 2 and 4.

Advantages and disadvantages to dynamically generating games or to serving pre-generated games will be recognized by those in the art, and it will be understood that features of system 100 and system 100′ can both be realized in the same computer system.

At this point it should be noted that techniques for automatically generating online games in accordance with the present disclosure as described above may involve the processing of input data and the generation of output data to some extent. This input data processing and output data generation may be implemented in hardware or software. For example, specific electronic components may be employed in a game generation engine or similar or related circuitry for implementing the functions associated with automatically generating online games in accordance with the present disclosure as described above. Alternatively, one or more processors operating in accordance with instructions may implement the functions associated with generating online games in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A computer-implemented method comprising:
automatically selecting an image from a plurality of images based on metadata associated with the selected image;
automatically applying a template to the selected image in order to generate a game level, the game level including the selected image.

2. The method of claim 1, further comprising:
presenting the game level including the selected image to a game player;
receiving behavioral data including data representing a response by the game player to the game level; and
modifying the metadata associated with the selected image based on the behavioral data.

3. The method of claim 1,
wherein the image is selected by searching an image repository including the plurality of images and metadata associated with each of the plurality of images; and
wherein searching the image repository comprises searching the metadata associated with each of the images in the image repository.

4. The method of claim 3, further comprising:
receiving a new image not included in the image repository;
associating metadata with the image; and
storing the image and the associated metadata within the image repository.

5. The method of claim 4,
wherein the new image is a product image associated with a product from a product catalog including information about products available for sale; and
wherein the associated metadata is based on the information included in the product catalog about the product associated with the product image.

6. The method of claim 4,
wherein the new image is an image submitted by a third party; and
wherein the associated metadata is based on information provided by the third party about the submitted image.

7. The method of claim 4, further comprising:
performing an image analysis on the new image to recognize the new image;
wherein the associated metadata is based on the image analysis.

8. The method of claim 1, further comprising:
publishing a game for play, the game including the game level with the selected image;
monitoring behavior of players of the game; and
evaluating the game's performance, the evaluation including providing at least one metric representing how the players respond to the game.

9. The method of claim 8, wherein the at least one metric includes at least one of a time spent playing the game, a difficulty of the game, player exposure to one or more products, and player purchase of one or more products.

10. A system, comprising:
an image repository storing a plurality of images, each image including metadata;
a template repository storing a plurality of game templates, each game template including instructions for automatically generating game levels using one or more images and the metadata of the one or more images; and
one or more processors operable to:
select at least one image from the image repository based on the metadata included with each image, and
automatically apply a template from the template repository to the selected at least one image in order to generate a game level, the game level including the selected at least one image.

11. The system of claim 10, further comprising:
a game repository storing a plurality of games generated from templates from the template repository.

12. The system of claim 10, further comprising:
a product catalog comprising a plurality of product records each including product information and at least one product image;
wherein the one or more processors is further operable to:
add a product image from a product record in the product catalog to the image repository, and
associate the image added to the image repository with metadata based on the product information associated with the product record.

13. The system of claim 10, wherein the one or more processors are further operable to:
present the game level including the selected image to a game player;
receive behavioral data including data representing a response by the game player to the game level; and
modify the metadata included with the selected image in the image repository based on the behavioral data.

14. The system of claim 10, wherein the image is selected by searching the metadata associated with each of the images in the image repository.

15. The system of claim 14, wherein the one or more processors are further operable to:
receive a new image not included in the image repository;
acquire metadata associated with the image; and
store the image including the associated metadata within the image repository.

16. The system of claim 15,
wherein the new image is an image submitted by a third party; and
wherein the included metadata is based on information provided by the third party about the submitted image.

17. The system of claim 15, further comprising:
performing an image analysis on the new image to recognize the new image;
wherein the included metadata is based on the image analysis.

18. The system of claim 10, wherein the one or more processors are further operable to:
publish a game for play, the game including the game level with the selected image;
monitor behavior of players of the game; and
evaluate the game's performance, the evaluation including providing at least one metric representing how the players respond to the game.

19. The system of claim 18, wherein the at least one metric includes at least one of a time spent playing the game, a difficulty of the game, player exposure to one or more products, and player purchase of one or more products.

20. The system of claim 10, further comprising:
a user profile database including a plurality of user profiles;
wherein selecting an image and applying a template are based on at least one of the user profiles within the user profile database.
